(19) United States
(12) Patent Application Publication
(10) Pub. No.: US 2007/0211139 A1
(43) Pub. Date: Sep. 13, 2007

(54) Video reproducing apparatus with telephone control functions

(75) Inventor: Tetsuo Makise, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/653,991

(22) Filed: Jan. 17, 2007

(30) Foreign Application Priority Data
Mar. 13, 2006 (JP) 2006-067579

(51) Int. Cl. H04N 7/14

(52) U.S. Cl. 348/14.01

(57) ABSTRACT

A video display apparatus connected to a network and a telephone set announces incoming telephone calls received from the network by displaying an on-screen text message superimposed on the video picture, and preferably by suppressing ringing of the telephone, so that a person watching the video display will not be unnecessarily distracted by incoming calls. The text message may include the caller's telephone number or name. The video display apparatus may also function as an answering machine for the telephone set.

### BACKGROUND OF THE INVENTION

1. Field of the Invention

The present invention relates to a video reproducing apparatus that outputs an image signal and also has telephone control functions.

2. Description of the Related Art

An apparatus that can reproduce video pictures such as television programs and recorded movies, for example, is normally controlled by a remote control device. If a telephone call arrives while the user is watching a movie or program, the user uses the remote control device to halt reproduction of the movie or program temporarily, answers the telephone, and then uses the remote control device again to resume reproduction of the movie or program when the telephone call is finished. This procedure is, however, somewhat inconvenient for the user, especially if the remote control device is not ready at hand.

A solution to this problem has been proposed in Japanese Patent Application Publication No. 2002-335479. The video reproducing apparatus is connected to and monitors signals on the telephone line. If a telephone call arrives while a movie or program is being watched, the video reproducing apparatus detects the ringing signal and automatically halts reproduction of the movie or program. When the call is finished, the video reproducing apparatus detects the on-hook state of the telephone and automatically resumes reproduction of the movie or program from the point at which reproduction was halted.

This solution, however, raises a new problem, in that the user may not want to interrupt the movie or program in order to answer the telephone. The user might even prefer for the telephone not to ring at all.

### SUMMARY OF THE INVENTION

An object of the present invention is to inform the user of a video reproducing apparatus of incoming telephone calls in a non-distracting way, without interrupting video reproduction.

A video reproducing apparatus according to the present invention is operative to display a video picture on a screen, and is also connected to a network that carries telephone calls. An incoming call detector in the video reproducing apparatus detects signals arriving from the network. A controller in the video reproducing apparatus responds to detection of a ringing signal by issuing an incoming call message display command. An on-screen display unit in the video reproducing apparatus responds to the incoming call message display command by displaying a text message on the screen to announce the incoming call. The text message is superimposed on the video picture, and may also give the caller's name or telephone number.

A person watching the video reproduction can accordingly keep watching while deciding whether or not to answer the telephone. To minimize distraction, the video reproducing apparatus may also have facilities for silencing the telephone's ringing tone and for operating as a telephone answering machine.

### BRIEF DESCRIPTION OF THE DRAWINGS

In the attached drawings:

FIG. 1 is a block diagram of an apparatus embodying the present invention;

FIG. 2 illustrates contents of the hard disk in FIG. 1;

FIG. 3 illustrates the sequence of operations by which the apparatus in FIG. 1 responds to an incoming telephone call;

FIG. 4 shows an exemplary video display indicating an incoming call;

FIG. 5 further illustrates the sequence of operations performed in response to an incoming telephone call;

FIG. 6 shows an exemplary video display indicating a recorded incoming message;

FIG. 7 illustrates a variation in the sequence of operations in FIG. 4; and

FIG. 8 illustrates a variation of the apparatus in FIG. 1.

### DETAILED DESCRIPTION OF THE INVENTION

An embodiment of the invention will now be described with reference to the attached drawings, in which like elements are indicated by like reference characters. The embodiment is a video recording and reproducing apparatus equipped with a hard disk drive.

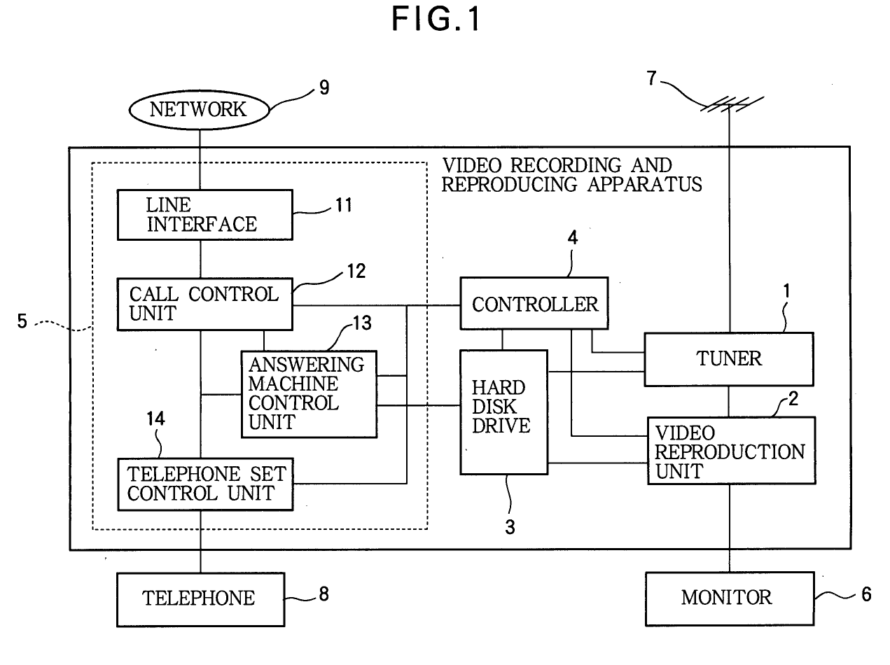

Referring to FIG. 1, the video recording and reproducing apparatus is connected to a network. The network 9 may be any network that carries telephone calls. The network 9 may, for example, be a public telephone network, or a computer communication network that uses the well-known Internet protocol (IP) to transmit telephone calls. The video recording and reproducing apparatus includes a tuner 1, a video reproduction unit 2, a hard disk drive 3, a controller 4, and a telephony section 5. The video recording and reproducing apparatus is also connected to a monitor 6 with a screen (not shown) for displaying a video picture, an antenna 7 for receiving broadcast television signals, and a telephone set 8 for originating and receiving calls.

The tuner 1 receives television signals from the antenna 7, selects a desired channel, and extracts a compressed digital video signal such as an MPEG-2 TS signal. MPEG-2 is a video compression standard established by the Motion Picture Experts Group and TS (Transport Stream) denotes a particular type of packetized digital video signal. The tuner 1 may also receive compressed digital video signals from a cable (not shown) instead of the antenna 7. The compressed digital video signal extracted by the tuner 1 is supplied to the video reproduction unit 2 and the hard disk drive 3.

The hard disk drive 3 includes a rotating magnetic disk (not shown) for storing the compressed digital video signal received from the tuner 1, and can supply stored compressed digital video signals to the video reproduction unit 2.

The video reproduction unit 2 decompresses the compressed digital video signal received from the tuner 1 or the hard disk drive 3 to obtain audio and video signals, which it sends to the monitor 6. The video reproduction unit 2 also function as an on-screen display unit; under the control of the controller 4, it can insert data into the decompressed video signal for display of information such as the channel selection.

The monitor 6 has one or more external input terminals for receiving the signals supplied by the video reproduction unit 2. The monitor 6 displays a corresponding video picture on its screen, and reproduces the audio signals through one or more loudspeakers (not shown).

The telephony section 5 includes a line interface 11, a call control unit 12, an answering machine control unit 13, and a telephone set control unit 14. The line interface 11 is connected to the network 9 by a telephone line, optical fiber cable, or any other type of communication link through which it receives telephone signals, and onto which it transmits signals from the other parts of the telephony section 5. The call control unit 12 controls the originating and receiving of calls and disconnection of the line: in originating a call, it sends call control signals through the line interface 11 to the network 9; in receiving a call, it receives call control signals through the line interface 11. The answering machine control unit 13 operates in the answering machine mode by automatically performing the processing necessary to receive and answer the call, including fetching an outgoing message from the hard disk drive 3 and recording an incoming message in the hard disk drive 3. The answering machine function can be enabled or disabled at the user's discretion.

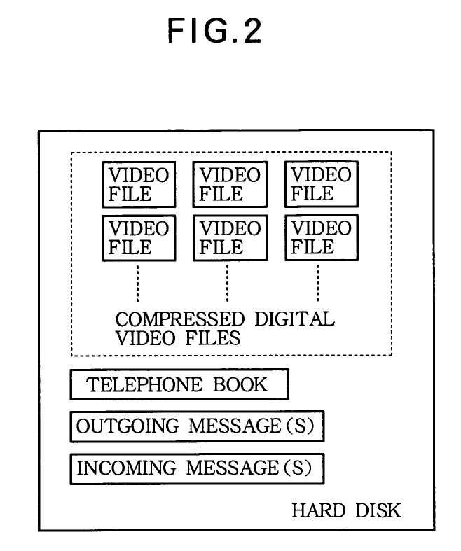

The rotating magnetic disk in the hard disk drive 3 stores not only video file content such as recorded television programs but also a ‘telephone book’ directory listing names and telephone numbers, one or more prerecorded outgoing messages, also referred to as greeting or guidance messages, and an arbitrary number of recorded incoming messages, as shown schematically in FIG. 2.

The telephone set control unit 14 controls the externally connected telephone set 8. When an incoming call arrives, the telephone set control unit 14 activates a ringing tone generator (not shown) in the telephone set 8, and then controls the incoming and outgoing speech signals in the telephone set 8. The telephone set control unit 14 may be connected to a simple handset or to a full-scale telephone set 8.

The controller 4 controls the operation of the tuner 1, video reproduction unit 2, hard disk drive 3, call control unit 12, answering machine control unit 13, and telephone set control unit 14.

Next, the operation of the video recording and reproducing apparatus will be described. It will first be assumed that the video reproduction unit 2 is sending audio and video signals to the monitor 6, that the monitor 6 is displaying a video picture, and that the answering machine function is disabled.

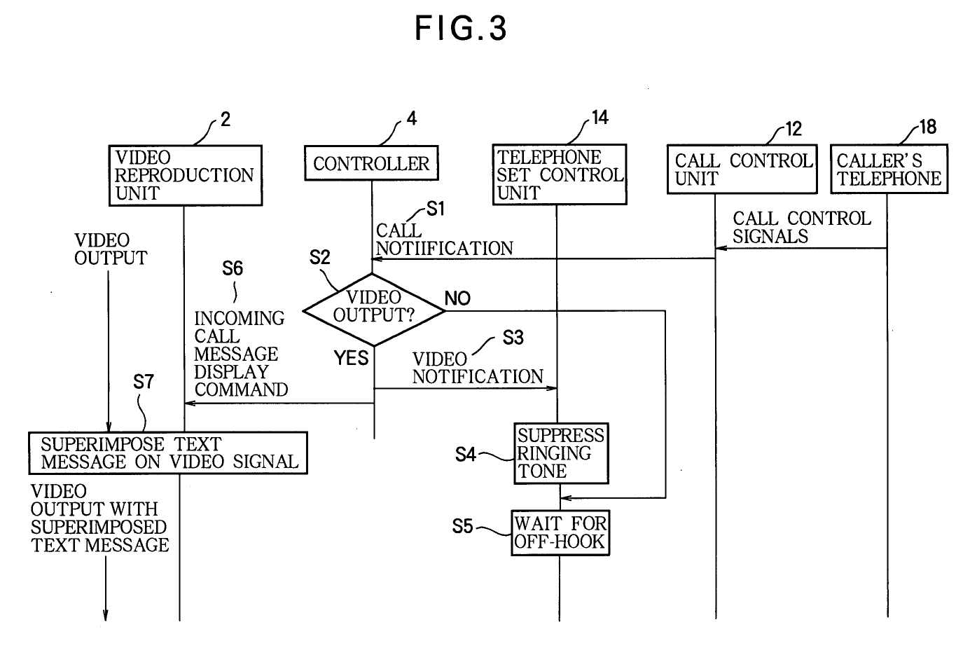

If an incoming call arrives in this state, the incoming call control signals indicated by the top right arrow in FIG. 3, including a ringing signal and a caller identification signal giving the caller's telephone number, reach the call control unit 12 from the caller's telephone 18 through the network 9 and line interface 11. The call control unit 12 notifies the controller 4 of the incoming call, including the caller's telephone number in the notification (step S1).

In response to this notification, the controller 4 first determines whether the video reproduction unit 2 is currently outputting a video signal (step S2). When the video reproduction unit 2 outputs audio and video signals, it also activates a video output status signal which it sends to the controller 4. The controller 4 determines whether or not the video reproduction unit 2 is outputting a video signal by determining whether or not the video output status signal is active. In the present case, the video output status signal is active, so the controller 4 sends a video output notification signal to the telephone set control unit 14 (step S3). In response to the video output notification signal, the telephone set control unit 14 suppresses the activation of the ringing tone generator in the telephone set 8 (step S4), and begins waiting for the telephone set 8 to go off-hook (step S5). During this time, the telephone set 8 does not ring. If the video output status signal were inactive, then steps S3 and S4 would be bypassed and the telephone set control unit 14 would begin waiting for the telephone set 8 to go off-hook without suppressing the ringing tone; that is, it would activate the ringing tone generator, so that the telephone set 8 would ring.

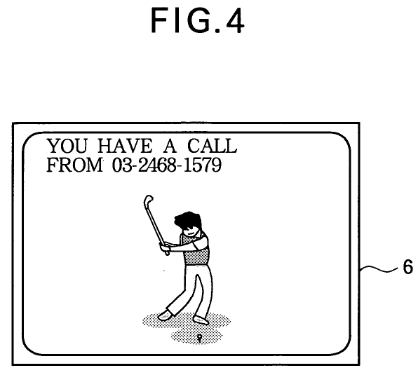

Following step S3, the controller 4 immediately sends an incoming call message display command to the video reproduction unit 2 (step S6). The incoming call message display command includes the telephone number received in step S1. The video reproduction unit 2 creates data for displaying a corresponding text message and uses a well-known superimposing technique to insert the data into the video signal sent to the monitor 6 (step S7). The text message is a short message announcing the incoming call and giving the caller's telephone number. The monitor 6 displays this message on the screen as shown, for example, in FIG. 4, superimposed on the video picture.

The user, who is watching the video picture on the screen, learns of the incoming call by seeing the displayed message. If the user decides to answer the call, the user picks up the handset of the telephone set 8, causing the telephone set control unit 14 to detect the off-hook state and send an off-hook detection signal to the call control unit 12. The call control unit 12 responds by sending an answer signal through the line interface 11 to the network 9. The answer signal is conveyed to the caller's telephone 18 and the user and caller begin conversing. The controller 4 may take further appropriate action at this point, such as reducing the volume of the audio signal.

If the user decides not to answer the call, the user can continue watching the video picture without being distracted by the ringing of the telephone set 8, since the ringing tone is suppressed. In other words, the video recording and reproducing apparatus is able to let the user know of the incoming call without letting the telephone set 8 ring.

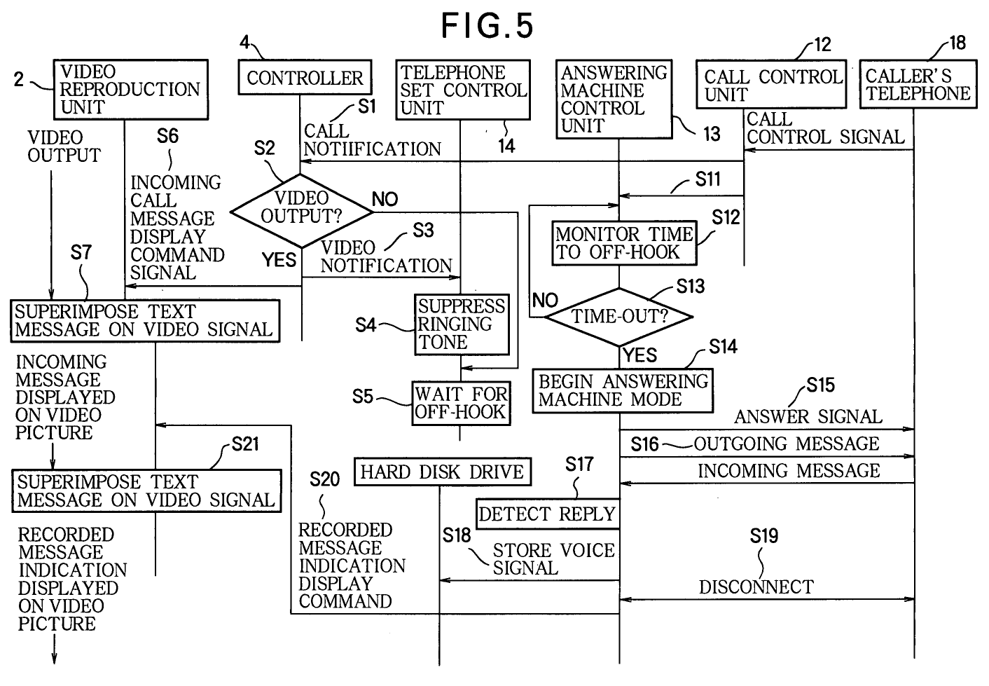

If the answering machine function is enabled, the above procedure is modified as shown in FIG. 5. Following step S1, in which the call control unit 12 notifies the controller 4 of the incoming call, the call control unit 12 also notifies the answering machine control unit 13 of the incoming call (step S1). The notification signal sent to the answering machine control unit 13 need not include the caller's telephone number.

The answering machine control unit 13 monitors the activity of the telephone set control unit 14 (step S12) and measures the time from arrival of the call until the telephone set 8 goes off-hook (step S13). If a preset time elapses without detection of the off-hook state, the answering machine control unit 13 switches over to the answering machine mode (step S14). In other words, if the user does not answer the call within a preset time from the start of the on-screen display announcing the arrival of the call, the answering machine function takes over.

In the answering machine mode, the answering machine control unit 13 generates an answer signal and sends it back to the caller (step S15). When the answer signal reaches the caller's telephone through the line interface 11 and the network 9, the call is connected, setting up a speech channel. Next, the answering machine control unit 13 reads a digitized outgoing message from the hard disk drive 3 and sends the message to the caller's telephone through the line interface 11 and network 9 (step S16). The outgoing message typically tells the caller that the called party is not at home or is unable to answer the telephone, and asks the caller to leave a message. After sending this outgoing message, the answering machine control unit 13 determines whether the caller replies to it (step S17). If the caller speaks, the answering machine control unit 13 detects the caller's voice signal, which it receives in digitized form, and stores the digitized voice signal as an incoming message in the hard disk drive 3 (step S18). When the message has been recorded or the caller has terminated the call, the answering machine control unit 13 sends the call control unit 12 an on-hook signal, causing the call control unit 12 to disconnect the line (step S19).

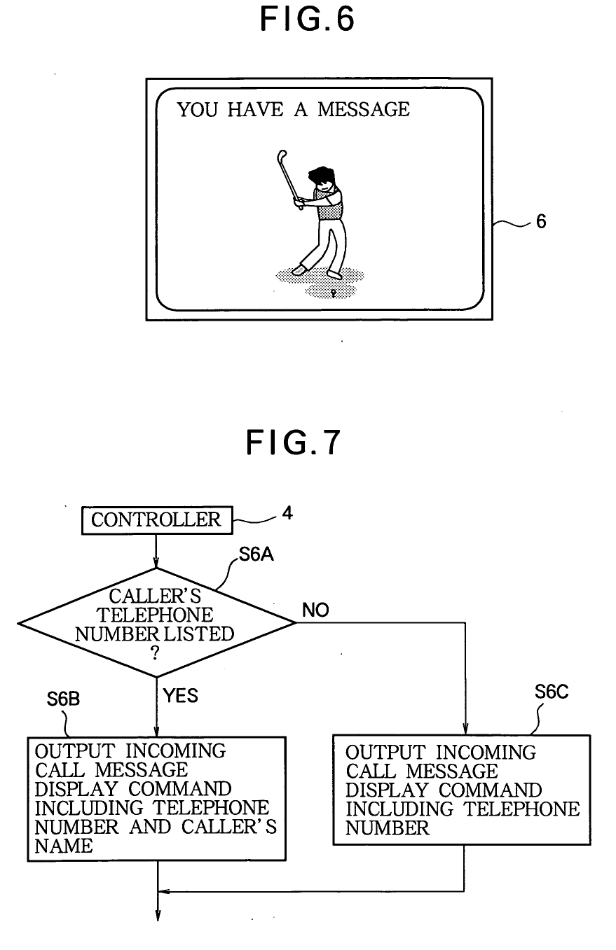

After recording the incoming message, the answering machine control unit 13 also instructs the controller 4 to send the video reproduction unit 2 a recorded message indication display command (step S20). This command need not include the caller's telephone number. Upon receiving this command, the video reproduction unit 2 creates data for displaying a corresponding text message and uses the above-mentioned superimposing technique to insert the data into the video signal sent to the monitor 6 (step S21). The monitor 6 displays the text message on the screen, superimposed on the video picture, as shown, for example, in FIG. 6. Seeing the message on the screen, the user learns of the existence of the recorded incoming message and can then listen to the message at a time of his or her convenience, by using the telephone set 8.

The procedure from step S11 to step S19 can be carried out even if the answering machine function is disabled by the user, or if the telephone set 8 is not equipped for use with an answering machine. Steps S20 and S21 may be disabled in this case, so that the user can watch or record a television broadcast without the annoyance of a persistent text message on the screen announcing the presence of a recorded telephone message. Later, the user can re-enable the answering machine function, or connect a different telephone set, and listen to the recorded incoming messages.

The present invention accordingly enables the video watcher to handle incoming calls as the viewer prefers, by answering the telephone, by having the call taken by the answering machine function, or by simply ignoring the call, without being distracted by a ringing telephone.

In a variation of the above embodiment, instead of simply sending an incoming call message display command including the caller's telephone number in step S6, the controller 4 follows the procedure shown in FIG. 7. First, the controller 4 accesses the telephone book data stored in the hard disk drive 3 to see whether the caller's telephone number is listed therein (step S6A). If it is, the controller 4 reads the caller's name from the telephone book data and places both the caller's name and the caller's telephone number in the incoming call message display command sent to the video reproduction unit 2 (step S6B). If the caller's telephone number is not found in the telephone book data, the controller 4 places the caller's telephone number in the incoming call message display command without the caller's name (step S6C). If step S6B is executed, the video reproduction unit 2 displays both the caller's name and the caller's telephone number in the message shown on the screen. Alternatively, only the caller's name may be displayed.

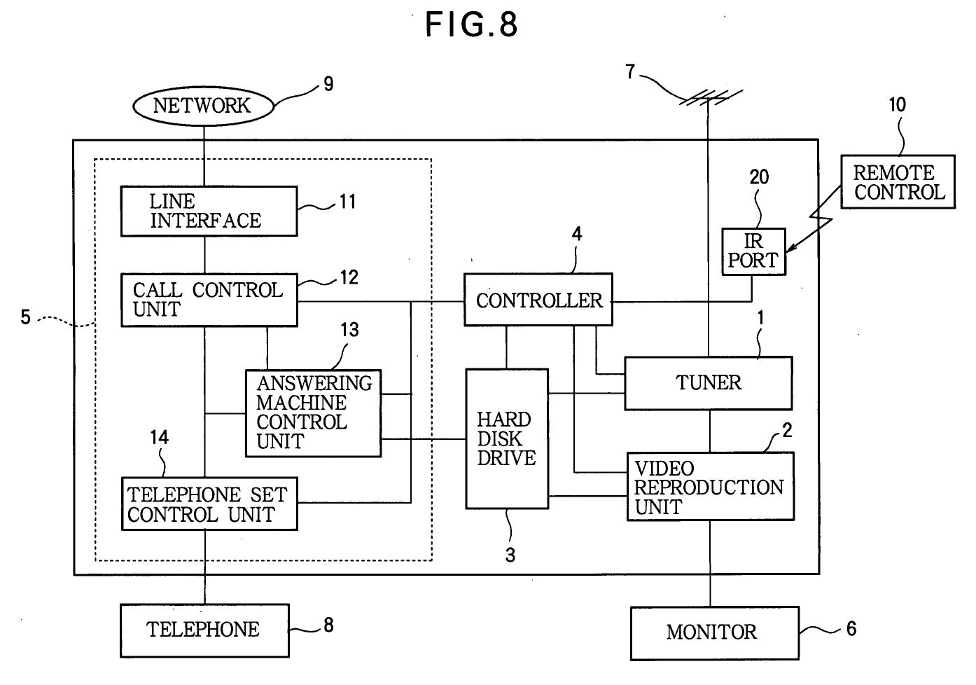

In another variation of the above embodiment, illustrated in FIG. 8, the video recording and reproducing apparatus is controlled by a hand-held remote control device 10, and has a built-in remote control receiver such as an infrared (IR) port 9 for receiving remote control signals from the remote control device 10. After seeing the text message announcing an incoming call, the user can use the remote control device 10 to transmit a signal activating the answering machine mode. When the video recording and reproducing apparatus receives this remote control signal after the display of a message announcing an incoming call, the answering machine control unit 13 switches immediately into the answering machine mode and sends an answer signal to the caller's telephone 18, followed by an outgoing message. This remote control function may be used instead of or in addition to the automatic switchover to the answering machine mode in'step S14 in FIG. 5.

In still another variation, instead of a hard disk drive, the apparatus has a semiconductor memory storing the data necessary for creating on-screen text messages. In this case the apparatus may not be able to record video signals, but it can still reproduce video signals and announce incoming calls with an on-screen message display, and may also be capable of functioning as an answering machine by using the semiconductor memory to store incoming and outgoing messages.

Some of the functional units shown in FIG. 1 may be software units. For example, the video recording and reproducing apparatus may be a computer equipped with software for carrying out the functions of the telephony section 5.

Those skilled in the art will recognize that further variations are possible within the scope of the invention, which is defined in the appended claims.

What is claimed is:

1. A video reproducing apparatus connected to a network, the video reproducing apparatus being operative to display a video picture on a screen, the video reproducing apparatus comprising:
an incoming call detector for detecting a ringing signal arriving from the network;
a controller for responding to detection of the ringing signal by issuing an incoming call message display command; and
an on-screen display unit for responding to the incoming call message display command by displaying a text message on the screen to announce the incoming call, the text message being superimposed on the video picture.

2. The video reproducing apparatus of claim 1, wherein the video signal is a television signal.

3. The video reproducing apparatus of claim 1, further comprising a telephone set control unit connected to a telephone set, the telephone set control unit responding to detection of the ringing signal by suppressing ringing of the telephone set.

4. The video reproducing apparatus of claim 1, wherein the ringing signal includes caller identification information giving a telephone number of a caller, the controller extracts the telephone number from the ringing signal and places the telephone number in the incoming call message display command.

5. The video reproducing apparatus of claim 4, wherein the on-screen display unit displays the caller's telephone number in the text message.

6. The video reproducing apparatus of claim 4, further comprising a data storage unit storing a directory of names and corresponding telephone numbers, wherein the controller looks up the extracted telephone number in the directory, reads the caller's name from the directory, and places the caller's name in the incoming call message display command, and the on-screen display unit also displays the caller's name in the text message.

7. The video reproducing apparatus of claim 1, further comprising an answering machine unit for answering the incoming call with a pre-recorded outgoing message and recording an incoming message spoken by the caller.

8. The video reproducing apparatus of claim 7, further comprising a telephone set control unit connected to a telephone set, for detecting an off-hook state of the telephone set, wherein the answering machine unit measures elapsed time from detection of the ringing signal to detection of the off-hook state, and answers the incoming call with the pre-recorded outgoing message if a predetermined time elapses before the off-hook state is detected.

9. The video reproducing apparatus of claim 7, wherein after recording the incoming message spoken by the caller, the answering machine unit sends a recorded message indication display command to the on-screen display unit, and the on-screen display unit displays a text message on the screen to announce the presence of the recorded incoming message, the text message being superimposed on the video picture.

10. The video reproducing apparatus of claim 1, further comprising:
a remote control transmitter for transmitting at least an answering machine activation signal; and
a remote control receiver for receiving the answering machine activation signal; wherein the controller activates the answering machine when the remote control receiver receives the answering machine activation signal after display of the text message.

11. The video reproducing apparatus of claim 8, wherein the video reproducing apparatus includes a computer with software for detecting the ringing signal, the controller and the incoming call detector forming part of the computer.
